(19) United States
(12) Patent Application Publication
(10) Pub. No.: US 2020/0285569 A1
(43) Pub. Date: Sep. 10, 2020

(54) TEST SUITE RECOMMENDATION SYSTEM

(71) Applicant: Sage Intacct, Inc., San Jose, CA (US)

(72) Inventors: Tina Tung, East Palo Alto, CA (US); Austin Jacobs, Hillsborough, CA (US); Clay Jacobs, Hillsborough, CA (US); Rajashekar Mani, Bangalore (IN); Gurvan Gadonna, Lannion (FR)

(21) Appl. No.: 16/297,243

(22) Filed: Mar. 8, 2019

(51) Int. Cl. G06F 11/36; G06N 20/00; G06N 5/04

(52) U.S. Cl. CPC G06F 11/3684; G06N 5/04; G06N 20/00; G06F 11/3688

(57) ABSTRACT

Test suite recommendations for testing a software application are automatically generated and applied. The system extracts and learns all available, relevant data concerning the intended operation of a software release; this information can be automatically obtained, for example, from engineering tools and systems, previous releases, and/or from other sources. Based on the extracted information, the system automatically recommends any number of test suites. In at least one embodiment, machine learning techniques are applied, so that the system is able to learn which tests and test suites are most effective for certain characteristics of software applications, and to learn what parameters for such tests should be applied. Once the system has automatically selected test suite(s), tests from the test suite(s) can be automatically run on the software product being developed. Results from such tests can be used to inform developers as to issues and/or problems with the software application.

### TECHNICAL FIELD

The present document relates to systems and methods for automatically selecting tests to be applied in product testing environments.

### BACKGROUND

A major part of software development is testing. In software development, a test suite is a set of tests that can be used to verify that an application is behaving as expected and does not contain flaws or bugs. Test suites usually contain detailed instructions and/or operational parameters associated with various test cases and situations. Once a test suite has been selected or established, tests from the suite can be run on the software application so as to ascertain how the software application functions under various conditions.

As a software application grows, more complex logic is added, in the form of new features and enhancements. The number of available test suites grows accordingly. In such situations, it is increasingly difficult for one person, or one group of people, to know the details of all available test suites and to select appropriate test suites to certify a particular release or version. In general, software developers have no effective mechanism or system for managing test suites in a manner that ensures that the appropriate test suite is applied to a particular software release.

### SUMMARY

According to various embodiments, a system and method are described for automatically generating recommendations of test suites for testing a particular software release or version. In at least one embodiment, the system extracts and learns all available, relevant data concerning the intended operation of a software release; this information can be automatically obtained, for example, from engineering tools and systems, previous releases, and/or from other sources. In at least one embodiment, the information is extracted from sources such as: a ticketing system for tracking issues and problems; various available test suites; source control system(s); release certification email(s); and/or the like. Then, based on the extracted information, the system automatically recommends any number of test suites.

In at least one embodiment, machine learning techniques are applied, so that the system is able to learn, in an automated manner, which tests and test suites are most effective for certain characteristics of software applications, and to learn what parameters for such tests should be applied. Such an approach can be implemented, for example, by developing a machine learning model that captures relevant characteristics of the software product, and by ascertaining the effectiveness of various test suites in connection with such characteristics, for example by performing tests on the machine learning model.

In at least one embodiment, the system operates in connection with a continuous integration (CI) development methodology. In such a methodology, changes are made more incrementally, rather than issuing less-frequent releases with more substantial changes. Since the collected data is more finely grained and is collected more frequently, machine learning can be used more effectively to improve prediction accuracy over time. The CI model facilitates and empowers the machine learning model to learn and adapt more quickly, rather than being limited to relatively infrequent updates following major releases. In effect, the system can run continuously, so that it automatically relearns and runs newly suggested tests suites in real-time, every time a new code revision is detected. Changes to the software application can be automatically detected in real-time so that they can be taken into consideration in identifying test suites in connection with the learning model. As the software application is made available to more users, new information is received; such information can then be used to ensure that the model stays current and accurate.

In addition, CI systems are effective for streamlining workflow, providing an improved process from a commit to automatically executing the recommended test suites.

In at least one embodiment, once the system has automatically selected test suites, tests from the test suite are run automatically on the software product being developed. Results from such tests can be used to inform developers as to issues and/or problems with the software application. In addition, in at least one embodiment, results from such tests can be provided to machine learning components so as to improve the operation of the test suite recommendation system in future iterations.

In this manner, the described system is able to reduce or eliminate the need to cross-train and educate personnel for manual determination of which tests to run in connection with particular software applications. In at least one embodiment, the system allows test suite recommendations to be made without requiring a human being to have knowledge of all available tests and test suites.

Further details and variations are described herein.

### BRIEF DESCRIPTION OF THE DRAWINGS

The accompanying drawings, together with the description, illustrate several embodiments. One skilled in the art will recognize that the particular embodiments illustrated in the drawings are merely exemplary, and are not intended to limit scope.

FIG. 1 is a block diagram depicting a hardware architecture for a test suite recommendation system, according to one embodiment.

FIG. 2 is a block diagram depicting a hardware architecture for a client device that can be used in connection with a test suite recommendation system, according to one embodiment.

FIG. 3 is a flow diagram depicting a method of operation for a test suite recommendation system, according to one embodiment.

FIG. 4 is a block diagram depicting additional details and relationships among components of the system, according to one embodiment.

FIG. 5 depicts an example of output generated from a test suite recommendation system, according to one embodiment.

### DETAILED DESCRIPTION OF THE EMBODIMENTS

The systems and methods set forth herein may be applied to many contexts in which it can be useful to generate recommendations for test suites for testing software applications. For illustrative purposes, the description herein is set forth with respect to a cloud computing-based architecture. One of skill in the art will recognize that the systems and methods described herein may be implemented in a wide variety of other contexts. In addition, the particular hardware arrangement depicted and described herein is a simplified example for illustrative purposes.

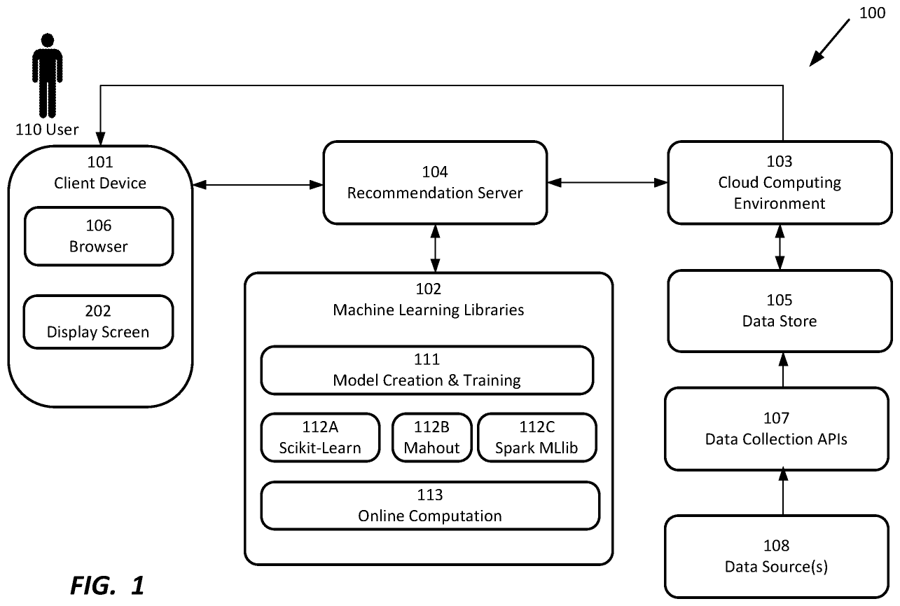

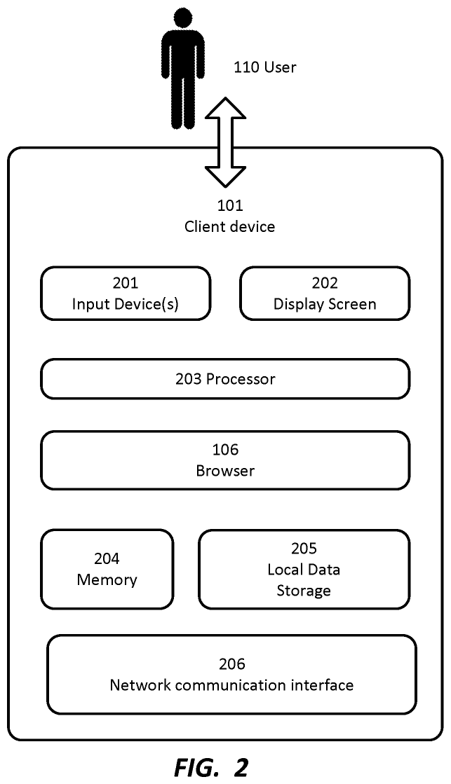

In some embodiments, one or more components, such as client device 101, recommendation server 104, cloud computing environment 103, and other components as shown and described in connection with FIGS. 1 and 2, may be used to implement the system and method described herein. For illustrative purposes, therefore, the system and method may be described in the context of such a cloud computing-based client/server architecture. One skilled in the art will recognize, however, that the system and method can be implemented using other architectures, such as for example a stand-alone computing device rather than a client/server architecture.

Further, the functions and/or method steps set forth below may be carried out by software running on one or more of the client devices 101, recommendation server 104, and/or cloud computing environment 103. This software may optionally be multi-function software that is used to retrieve, store, manipulate, and/or otherwise use data stored in data storage devices such as data store 105, and/or to carry out one or more other functions.

In this application, a “user” is an individual, enterprise, or other group, which may optionally include one or more users. A “data store” is any device capable of digital data storage. A data store may use any known hardware for nonvolatile and/or volatile data storage. A “data storage system” is a collection of data stores that can be accessed by multiple users. A “computing device” is any device capable of digital data processing. A “server” is a computing device that provides data storage, either via a local data store, or via connection to a remote data store. A “client device” is an electronic device that communicates with a server, provides output to a user, and accepts input from a user.

### System Architecture

According to various embodiments, the system and method can be implemented on any electronic device or set of interconnected electronic devices, each equipped to receive, store, and present information. Each electronic device may be, for example, a server, desktop computer, laptop computer, smartphone, tablet computer, and/or the like. As described herein, some devices used in connection with the system described herein are designated as client devices, which are generally operated by end users. Other devices are designated as servers, which generally conduct back-end operations and communicate with client devices (and/or with other servers) via a communications network such as the Internet. In at least one embodiment, the methods described herein can be implemented in a cloud computing environment using techniques that are known to those of skill in the art.

In addition, one skilled in the art will recognize that the techniques described herein can be implemented in other contexts, and indeed in any suitable device, set of devices, or system capable of interfacing with existing enterprise data storage systems. Accordingly, the following description is intended to illustrate various embodiments by way of example, rather than to limit scope.

Referring now to FIG. 1, there is shown a block diagram depicting a hardware architecture for a test suite recommendation system 100, according to one embodiment.

Client device(s) 101 and recommendation server 104 may be any suitable electronic devices configured to perform the steps described herein. In at least one embodiment, client device 101 includes functionality for running browser 106 or similar software for accessing websites over a network such as the Internet. Display screen 202 is an example of an output device that can be used for generating output for user 110.

In at least one embodiment, recommendation server 104 operates in connection with machine learning libraries 102 that support machine learning functionality so as to provide improved test suite recommendations, according to techniques described herein. Examples of such machine learning libraries 102 include modules 111 for model creation and training; Scikit-Learn 112A; Mahout 112B; Spark MLlib 112C; and any suitable modules 113 for online computation.

Mahout 112B and Spark MLlib 112C are examples of machine learning frameworks that can be used, in the context of the described system, to perform large numbers of I/O calculations. Scikit-Learn 112A can be used, in one embodiment, for quick prototyping, data analytics, and fine tuning of features/parameters, allowing the engineering team to be able to graph data easily to provide improved accuracy with less programming required.

In at least one embodiment, machine learning libraries 102 implement a machine learning algorithm that can incorporate one or more of the following, in any suitable combination:
natural language processing;
co-occurrence matrix;
clustering;
K-means;
Pearson correlation similarity;
generic item-based/content-based recommender;
Tanimoto coefficient similarity;
SVD; and
collaborative filtering.

Any combination of the above algorithms and methods (or some subset thereof) is used to test the data in order to obtain the best results. In at least one embodiment, natural language processing techniques are used to understand commit messages, plain-text test suites descriptions, and other free text forms. For unstructured data, clustering can be used to understand the basic groups of the data being analyzed. In at least one embodiment, data transformation can be used by applying additional structure and/or collecting more information, as may be beneficial or useful for the operation of the machine learning algorithms. Once the data has been processed in this manner, the recommendation system is built using whichever algorithm provides the highest level of accuracy.

An open source automation server such as Jenkins can be used to coordinate operations of machine learning libraries 102 and recommendation server 104, so as to implement a fully automated test suite recommendation system, as described herein.

In at least one embodiment, system 100 also includes cloud computing environment 103. Such an environment involves the use of a network of remote servers that communicate with one another via a network such as the Internet, in order to perform the functions and operations described herein. In at least one embodiment, cloud computing environment 103 is implemented in an elastic environment that allocates resources automatically in response to need, thus allowing for improved adaptability to changing conditions in workload and demands. One example of such a cloud computing environment 103 is Amazon Web Services, an on-demand cloud computing platform available from Amazon.com, Inc. of Seattle, Wash.

One skilled in the art will recognize, however, that system 100 can be implemented using other architectures and techniques, and that the particular cloud computing architecture described herein is merely exemplary.

In at least one embodiment, cloud computing environment 103 operates in connection with one or more data store(s) 105, each of which can store data according to any suitable protocol. In at least one embodiment, data can be organized into one or more databases. Any number of data store(s) 105 can be provided. Each database may include one or more well-ordered data sets, which may include data records, metadata, and/or other data (not shown). Each data set may include one or more data entries. Data store(s) 105, however, can have any suitable structure. Accordingly, the particular organization of data store(s) 105 need not resemble the form in which information from data store(s) 105 is displayed to user 110. In at least one embodiment, an identifying label is also stored along with each data entry, to be displayed along with each data entry.

In at least one embodiment, data store(s) 105 may be organized in a file system, using well known storage architectures and data structures, such as relational databases. Examples include Oracle, MySQL, and PostgreSQL. Appropriate indexing can be provided to associate data elements in data store(s) 105 with each other. In at least one embodiment, data store(s) 105 may be implemented using cloud-based storage architectures such as NetApp (available from NetApp, Inc. of Sunnyvale, Calif.) and/or Google Drive (available from Google, Inc. of Mountain View, Calif.).

In at least one embodiment, data in data store(s) 105 come from data collection application programming interfaces (APIs) 107, which collect data from any suitable data source(s) 108. Examples of data source(s) 108 include versioning systems such as Subversion, cloud-based applications such as Google Sheets, accounting software such as Intacct, a ticketing system such as TicketMaster, calendaring software such as Microsoft Outlook, and/or the like, as follows:
For Subversion, in at least one embodiment, client command “svn log-vv” can be executed on one of Jenkins' slaves to obtain the history and write to a file. Data collected from Subversion include, for example: timestamp; file is added/modified/deleted; full file path; folder name; commit message; filename; author; and ticket tracking system ticket number. Ticket numbers can then be used to query a ticketing system via API calls to retrieve additional information.
For Google Sheets, in at least one embodiment, a Google App Script is used to automatically convert the Google Doc into a csv file. The converted CSV file is stored on Google Drive, which is then retrieved via a Google Drive REST API running on a Jenkins slave.
For Microsoft Outlook, in at least one embodiment, the system parses release certification emails via a VBScript script.

Client device(s) 101, recommendation server 104, machine learning libraries 102, cloud computing environment 103, and other components of system 100 communicate with one another via any suitable communications network, such as the Internet, according to any suitable protocols and techniques. In addition to the Internet, other examples include cellular telephone networks, EDGE, 3G, 4G, long term evolution (LTE), Session Initiation Protocol (SIP), Short Message Peer-to-Peer protocol (SMPP), SS7, Wi-Fi, Bluetooth, ZigBee, Hypertext Transfer Protocol (HTTP), Secure Hypertext Transfer Protocol (SHTTP), Transmission Control Protocol/Internet Protocol (TCP/IP), and/or the like, and/or any combination thereof. In at least one embodiment, browser 106 running on client device 101 transmits requests for data via the communications network, and receives responses from recommendation server 104 containing the requested data, which many include test suite recommendations, as described in more detail below. Such requests may be sent via HTTP as remote procedure calls or the like. The communications network may employ any known technologies to ensure secure communications between client device(s) 101 and recommendation server 104.

In at least one embodiment, cloud computing environment 103 may include additional components as needed for retrieving data from data store 105 in response to requests from client device 101. In at least one embodiment, recommendation server 104 may include additional components as needed for interacting with machine learning libraries 102 and cloud computing environment 103 in response to requests from client device 101.

In some embodiments, the data within data store 105 may be distributed among multiple physical servers. Thus, data store 105 as depicted in FIG. 1 may represent one or more physical storage locations, which may communicate with each other via the communications network and/or one or more other networks (not shown). In addition, recommendation server 104 as depicted in FIG. 1 may represent one or more physical servers, which may communicate with each other via the communications network and/or one or more other networks (not shown).

Referring now to FIG. 2, there is shown a block diagram depicting a hardware architecture for a client device 101 that can be used in connection with the overall architecture depicted in FIG. 1, according to one embodiment. User 110 interacts with client device 101 by providing input to device 101 and by viewing output presented by device 101. Such interactions are described in more detail herein.

In at least one embodiment, client device 101 can be any suitable electronic device and can include a number of hardware components that are well-known to those skilled in the art. Input device(s) 201 can include any element(s) that receive input from user 110, including, for example, a keyboard, mouse, stylus, touch-sensitive screen (touchscreen), touchpad, trackball, accelerometer, five-way switch, microphone, or the like. Input can be provided via any suitable mode, including for example, one or more of: pointing, tapping, typing, dragging, and/or speech.

Display screen 202 can be any element that graphically displays information, such as data from server(s) 102, 103, and/or from data store(s) 105, as well as user interface elements that can facilitate interaction with such information. In at least one embodiment where only some of the desired output is presented at a time, a dynamic control, such as a scrolling mechanism, may be available via input device(s) 201 to change which information is currently displayed, and/or to alter the manner in which the information is displayed.

Local data storage 205 can be any magnetic, optical, or electronic storage device for data in digital form; examples include magnetic hard drive, CDROM, DVD-ROM, flash drive, USB hard drive, or the like. In various embodiments, local data storage 205 is detachable or removable from client device 101, or it may be is fixed within client device 101.

In at least one embodiment, local data storage 205 stores information that can be utilized and/or displayed according to the techniques described below. Local data storage 205 may be implemented in a database or using any other suitable arrangement. In another embodiment, data can be stored elsewhere, and retrieved by client device 101 when needed for presentation to user 110. Local data storage 205 may store one or more data sets, which may be used for a variety of purposes and may include a wide variety of files, records, and/or other data. In at least one embodiment, data can be stored in local data storage 205, either in whole or in part, instead of or in addition to being stored at data store(s) 105 associated with server(s) 103.

In some embodiments, records from data store(s) 105 can include elements distributed between server 103 and client device 101 and/or other computing devices in order to facilitate secure and/or effective communication between these computing devices. In some embodiments, such records may all be stored primarily on server 103, and may be downloaded to client device 101 when needed by the user 110 for viewing and/or modification according to the techniques described herein. When viewing or modification is complete, the records may be updated on server 103. The corresponding copies of the records on client device 101 may be deleted.

Local data storage 205 can be local or remote with respect to the other components of client device 101. In at least one embodiment, client device 101 is configured to retrieve data from a remote data storage device when needed. Such communication between client device 101 and other components can take place wirelessly, by Ethernet connection, via a computing network such as the Internet, via a cellular network, or by any other appropriate means.

Processor 203 can be a conventional microprocessor for performing operations on data under the direction of software, according to well-known techniques. Memory 204 can be random-access memory, having a structure and architecture as are known in the art, for use by processor 203 in the course of running software, presenting information to user 110, receiving input from user 110, and/or communicating with other components of the system. Network communication interface 206 is an interface that enables communication with other components of system 100 via any suitable electronic network, using techniques that are known in the art.

In at least one embodiment, the system is implemented using a “black box” approach, whereby data storage and processing are done independently from user input/output. An example of such an approach is a web-based implementation, wherein client device 101 runs browser 106 that provides a user interface for interacting with web pages and/or other web-based resources generated by recommendation server 104. Items from recommendation server 104 can be presented as part of such web pages and/or other web-based resources, using known protocols and languages such as Hypertext Markup Language (HTML), Java, JavaScript, and the like.

Client device 101 can be any electronic device incorporating the elements depicted in FIG. 2, such as a desktop computer, laptop computer, personal digital assistant (PDA), cellular telephone, smartphone, music player, handheld computer, tablet computer, kiosk, game system, wearable device, or the like.

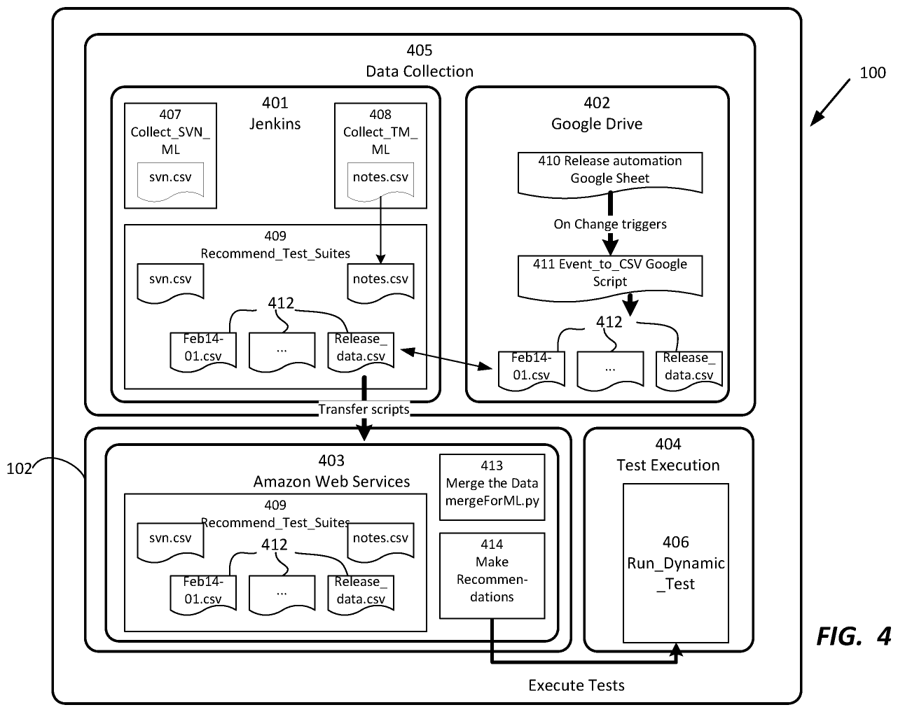

Referring now to FIG. 4, there is shown a block diagram depicting additional details and relationships among components of system 100, according to one embodiment.

In one embodiment, some or all components of the system can be implemented in software written in any suitable computer programming language, whether in a standalone or client/server architecture. Alternatively, some or all components may be implemented and/or embedded in hardware.

As shown in FIG. 4, system 100 includes three functional components: data collection module 405, machine learning module 102, and test execution module 404. Each will be described in turn.

In at least one embodiment, data collection module 405 is implemented using Jenkins 401 and Google Drive 402, although one skilled in the art will recognize that other services and/or products can be used. Two projects, or jobs, are implemented within Jenkins 401: Collect_SVN_ML 407 and Collect_TM_ML 408; these work together to collect data for testing. Specifically, Collect_SVN_ML 407 collects data from Subversion and places it in a file called svn.csv. Collect_TM_ML 408 collects data from a ticketing system such as TicketMaster (available from Sage Intacct, Inc. of San Jose, Calif.) and places it in a file called notes.csv.

In at least one embodiment, each release (such as Feb14-01) is a collection; all information for each release is extracted from TicketMaster and saved in files 412. Release_data.csv may include, for example, high level data containing all the releases and some high level information. In at least one embodiment, Release_Data.csv can include information such as Test Suite Name, Test description, Test Case Count, Time it takes, Test Data used, and number of times it is executed.

Once data has been collected, Jenkins 401 calls Recommend_Test_Suites 409, which is a Jenkins job for generating recommended test suites, using the techniques described herein.

In at least one embodiment, Recommend_Test_Suites 409 runs a script to merge data files collected by Collect_SVN_ML 407 and Collect_TM_ML 408. Recommend_Test_Suites 409 also calls machine learning module 102, which is implemented using Amazon Web Services 403 or another cloud-based service. Machine learning module 102 executes a script that merges 413 the data file, and then uses the merged data file to learn and create the model before making the recommendation 414. A list of test suite names is returned.

In at least one embodiment, machine learning module 102 is implemented using Spark MLlib, Python, Hadoop, or any combination thereof, running on Amazon Web Services 403 and/or another cloud-based service. Machine learning module 102 executes a script that merges 413 the data file, and then uses the merged data file to learn and create the model before making the recommendation 414. A list of test suite names is returned.

In at least one embodiment, data can also be collected from any other suitable source, such as Google Drive 402. Release automation information 410 can be stored, for example on a Google Sheet; any changes trigger Event_to_CSV Google script 411, which causes data collected from TicketMaster (and/or other sources) to be stored in files 412.

In at least one embodiment, changes to release automation document 410 (which may be a Google Sheet) are detected and fed to an Event_to_CSV Google script 411. Documents 412 are generated by script 411 and provided to Recommend_Test_Suites 409.

Recommend_Test_Suites 409 calls Run_Dynamic_Test 406, which is a job running on Jenkins platform 405 within test execution module 404. Run_Dynamic_Test 406 executes the specified API tests in an XML Gateway tester framework. Results from the test are then sent to the developers, QA, and configured recipients automatically.

### Method

The techniques described herein provide improved test suite recommendations for testing software applications. As developers make changes to software applications, new tests can be generated and provided, for example by quality assurance (QA) personnel. For example, if new features are added, QA personnel may generate new tests to verify that the new features are working properly. When such new tests become available, a new test suite can be developed so as to incorporate a suitable set of tests to make sure the application as a whole is operating as desired. The techniques described herein apply machine learning to generate recommendations as to an optimal test suite to be applied in any given situation and combination of features.

In at least one embodiment, the system excludes the basic set of tests that are always run for every release, so that the same tests need not be specifically recommended each time. The system reads test suites survey information and learns about the modules that each test suites belongs to. Collected data is then combined. A correlation algorithm is run, to obtain us a rating of each of the tests that most correlate to the most recent changes made to the software application. In at least one embodiment, a “boost threshold” parameter can be used to further fine-tune the results. Boosting is a technique in machine learning that allows logistic regression to give greater weight to certain features/classes and thereby choose the best feature(s) from a set of features. The boost threshold parameter returns probabilities that can then be used to assign weights.

In at least one embodiment, on the top five selected tests are returned. In other embodiments, other numbers of tests can be returned. In at least one embodiment, the system returns any test suites achieving a score above a certain threshold. The corresponding test names are returned.

Further details will be provided below.

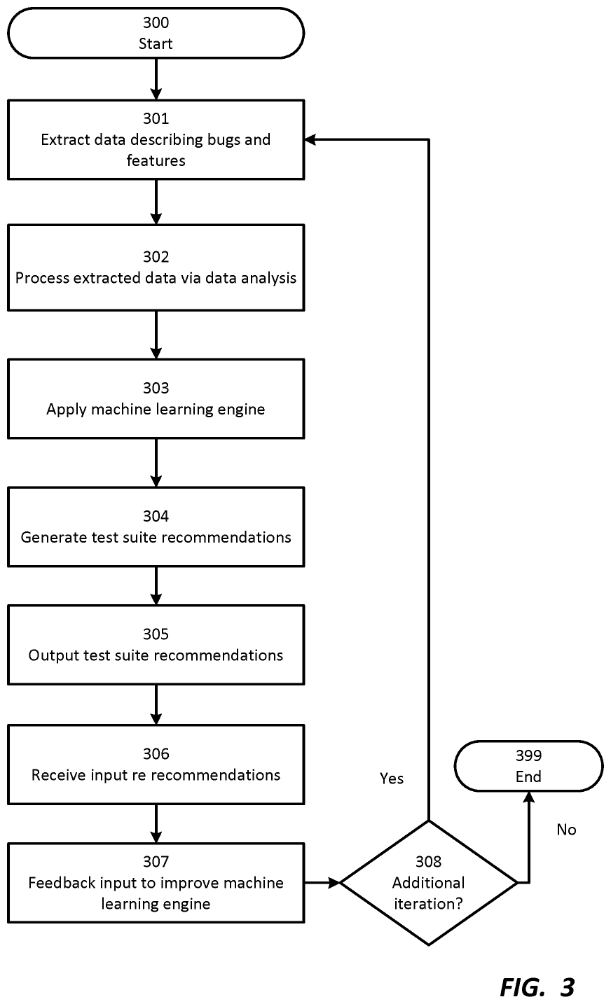

Referring now to FIG. 3, there is shown a flow diagram depicting a method of operation for a test suite recommendation system, according to one embodiment. In at least one embodiment, the method of FIG. 3 is implemented in a hardware architecture as described above and as depicted in FIGS. 1, 2, and 4; however, one skilled in the art will recognize that the method can be performed using other architectures. Any of the different components depicted in FIGS. 1, 2, and 4, and/or other components, may perform the various steps depicted in FIG. 3, in any suitable sequence or combination.

The method begins 300. First system 100 extracts 301 data describing bugs and features of the software application to be tested. In at least one embodiment, data is extracted from a ticketing system that is used for reporting and collecting information on issues and problems with the software application. Such a ticketing system may store, in a database, information describing the issue or problem, the time and date it occurred, the circumstances in which it occurred, the platform, and an identifier of the person reporting the issue or problem.

Another source of information for step 301 is the developer, who may have indicated what features or code have been added or changed in a particular software revision. Information describing such additions and changes can be extracted from a database or other repository that indicates what features were added or changes, the date and time the change was made, a description of the change, the name of the coder and/or reviewer, and/or other information. Such database or repository can be updated, for example, whenever a software revision is committed; such an operation logs the user ID of the person committing the revision, and causes a new revision ID to be generated and stored. Any suitable revision ID paradigm can be used; for example, in at least one embodiment, a series of sub-versions can be identified between major revisions.

The extracted data is then processed 302, using data analysis techniques. For example, in at least one embodiment, the current release (or version) of the software application is compared with the previous release, so that the test suite recommendation system can focus on those features and elements that were changed or added. A correlation score can be developed to indicate a degree of relative similarity of the current release to previous releases. Then, tests that apply to features and elements that have already been tested in previous versions can be deleted or given less importance, while tests of new features and elements can be emphasized.

In at least one embodiment, some tests may be deemed to be important for all releases, including those that are similar to previous releases. Those tests can be included in all test suites for execution regardless of the similarity of the current release to previous releases.

In at least one embodiment, based on such analysis, the system determines attributes or features should be emphasized for testing. Repetitive learning can be applied to automatically determine which attributes or features are most important to test.

In at least one embodiment, the system takes into account user input to make such determinations. Any suitable form of input can be provided, including user indications of which attributes or features are most important or are newly added. In at least one embodiment, a natural language processor can be provided, to more readily collect information from the user using natural speech. The natural language processor can be configured to identify certain key words and thereby extract relevant information as to which attributes or features are most important.

In at least one embodiment, certain attributes or features of the software application can be manually flagged, so that greater weight is given to those attributes or features when determining what tests should be executed.

A machine learning engine, using resources from machine learning libraries 102, is applied 303, and test suite recommendations are generated 304. In at least one embodiment, the machine learning engine uses a collaborative filtering approach to generate recommendations, although any other known recommendation technology can be used. In at least one embodiment, a Pearson correlation model and/or single-value-decomposition (SVD) model can be used, although other techniques can also be used.

In at least one embodiment, a clustering approach can be used. In such an approach, tests are clustered into groups, wherein tests within a group are similar to one another and can be treated similarly. Once a cluster of tests has been defined, either manually or automatically, the cluster can be treated as a single unit for recommendation purposes.

In at least one embodiment, clustering is performed using a machine learning algorithm. The algorithm is applied to the unsupervised data. Clustering can be applied to a large set of data to automatically divide the data into a number of groups, for example to group similar test suites with one another, particularly if the test suites test the same areas of code. Upon determining that a particular test suite is being executed, the system can then decide that the rest of the test suites in the same group should be automatically executed, so as to provide more testing coverage. Alternatively, the system can skip the rest of the test executions since one test suite has already been selected and is testing similar areas/functionality in the code. Thus, clustering enables informed decisions as to whether to test in a shallow manner or more deeply. In at least one embodiment, a K-means clustering algorithm is used.

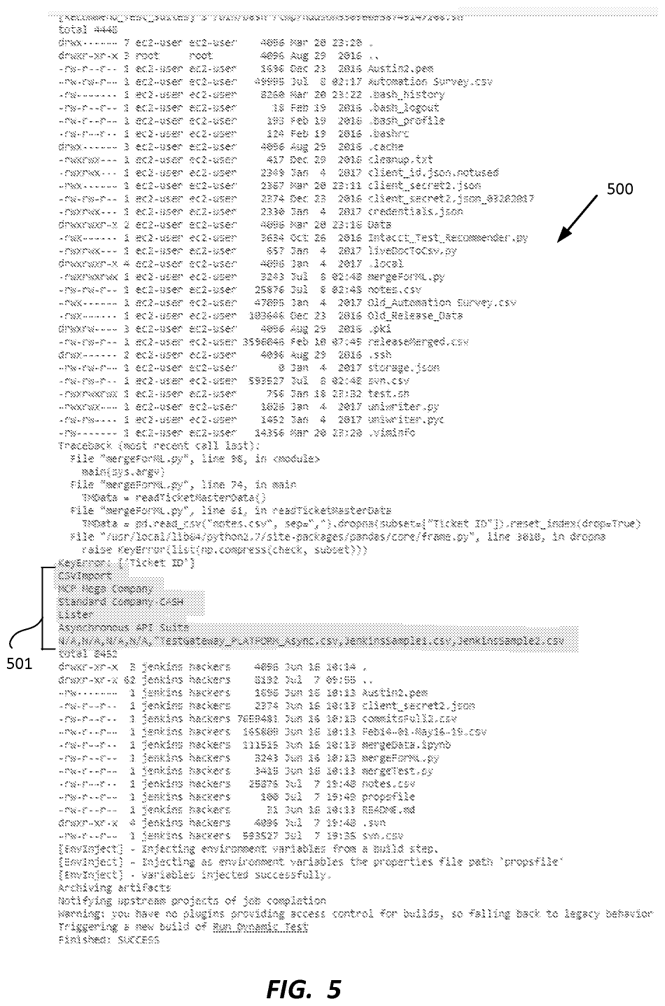

These recommendations are then output 305 to user 110, for example, by displaying output on display screen 202 of client device 101. The recommendations can include, for example, a test suite specifying a set of tests that should be run on the software application. Any suitable format can be used for presenting this output, such as for example a list of test suites, or some graphical representation. Referring now to FIG. 5, there is shown an example of output 500 generated from a test suite recommendation system, including a list 501 of test suites, according to one embodiment.

The tests are then applied to the software application. In at least one embodiment, the tests are run automatically, using Jenkins. Alternatively, once output 305 is provided to user 110, user 110 can manually select and run the desired tests from the specified test suite.

In at least one embodiment, a feedback loop is enabled, wherein user feedback is used to improve the performance of the machine learning engine so as to provide more effective test suite recommendations. User 110 can be prompted to enter input, via input device 201, as to the quality of previously output test suite recommendations. Other input can also be received, including for example automatically generated metrics and measures indicating the quality of previously output test suite recommendations. Such automatically generated metrics can indicate, for example, whether the specified test suite was successful in detecting problems or issues with the software application.

Once this input has been received 306, the input is fed back 307 into the machine learning engine, under the direction of model creation and training module 111. Known machine learning techniques can be used for improving machine learning engine performance in response to such feedback, for example by suggesting modifications to selected tests and/or test parameters.

If any additional iterations are needed 308, for example to perform additional testing of the software application, the method returns to step 301. Otherwise, the method ends 399.

The method depicted in FIG. 3 allows test suite recommendations to improve over time. Specifically, the feedback loop allows the system to learn from previous iterations; for example, if a software application testing situation is determined to have similar characteristics as a previously encountered situation, techniques that were effective in the previous situation can be reused, while techniques that were less effective can be avoided.

In at least one embodiment, when a change is made to the software application, a user or administrator provides input indicating the change; this may include, for example, a new or changed feature, new underlying code, new user interface, or the like. In at least one embodiment, the input is provided to a Jenkins job. In response to such input, system 100 combines the new information reflecting the changes with previous data indicating test suite recommendations, so as to train the machine learning engine and generate new recommendations. In at least one embodiment, Jenkins trains the model and generates new test suite recommendations.

For example, a software product may have a release cycle that includes quarterly releases that include major revisions, along with weekly production code updates. Each deployment introduces some changes to the software application, and therefore potentially introduces new issues and/or problems (bugs). Information for testing the application can come from a list of new and/or changed features, as well as from issues reported through the ticketing system. With each release, a set of active tickets (corresponding to issues with the software) is referenced, so that a test suite can be generated using the techniques described herein, that can effectively test new or changed features as well as ensure that previously identified problems and issues have been resolved. In at least one embodiment, the set of active tickets can be identified with reference to ticket identifiers in a stored database.

In at least one embodiment, data describing test suites can be organized as a test suite survey, which is a collection of various users' information describing a test suite. Such collection can be stored in any suitable format, such as a spreadsheet or database. In at least one embodiment, such collection can include, for example, a description and name for each test suite, a pathname, the particular workflow or functionality being tested, and/or the like.

In at least one embodiment, a particular test suite may test multiple modules that may be involved in executing a particular action or performing a particular function. In this manner, the test suite can provide tests for the entire action or function, even though such tests involve multiple modules.

One skilled in the art will recognize that the examples depicted and described herein are merely illustrative, and that other arrangements of user interface elements can be used. In addition, some of the depicted elements can be omitted or changed, and additional elements depicted, without departing from the essential characteristics.

The present system and method have been described in particular detail with respect to possible embodiments. Those of skill in the art will appreciate that the system and method may be practiced in other embodiments. First, the particular naming of the components, capitalization of terms, the attributes, data structures, or any other programming or structural aspect is not mandatory or significant, and the mechanisms and/or features may have different names, formats, or protocols. Further, the system may be implemented via a combination of hardware and software, or entirely in hardware elements, or entirely in software elements. Also, the particular division of functionality between the various system components described herein is merely exemplary, and not mandatory; functions performed by a single system component may instead be performed by multiple components, and functions performed by multiple components may instead be performed by a single component.

Reference in the specification to “one embodiment” or to “an embodiment” means that a particular feature, structure, or characteristic described in connection with the embodiments is included in at least one embodiment. The appearances of the phrases “in one embodiment” or “in at least one embodiment” in various places in the specification are not necessarily all referring to the same embodiment.

Various embodiments may include any number of systems and/or methods for performing the above-described techniques, either singly or in any combination. Another embodiment includes a computer program product comprising a non-transitory computer-readable storage medium and computer program code, encoded on the medium, for causing a processor in a computing device or other electronic device to perform the above-described techniques.

Some portions of the above are presented in terms of algorithms and symbolic representations of operations on data bits within a memory of a computing device. These algorithmic descriptions and representations are the means used by those skilled in the data processing arts to most effectively convey the substance of their work to others skilled in the art. An algorithm is here, and generally, conceived to be a self-consistent sequence of steps (instructions) leading to a desired result. The steps are those requiring physical manipulations of physical quantities. Usually, though not necessarily, these quantities take the form of electrical, magnetic or optical signals capable of being stored, transferred, combined, compared and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations of physical quantities as modules or code devices, without loss of generality.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “displaying” or “determining” or the like, refer to the action and processes of a computer system, or similar electronic computing module and/or device, that manipulates and transforms data represented as physical (electronic) quantities within the computer system memories or registers or other such information storage, transmission or display devices.

Certain aspects include process steps and instructions described herein in the form of an algorithm. It should be noted that the process steps and instructions can be embodied in software, firmware and/or hardware, and when embodied in software, can be downloaded to reside on and be operated from different platforms used by a variety of operating systems.

The present document also relates to an apparatus for performing the operations herein. This apparatus may be specially constructed for the required purposes, or it may comprise a general-purpose computing device selectively activated or reconfigured by a computer program stored in the computing device. Such a computer program may be stored in a computer readable storage medium, such as, but is not limited to, any type of disk including floppy disks, optical disks, CD-ROMs, DVD-ROMs, magnetic-optical disks, read-only memories (ROMs), random access memories (RAMs), EPROMs, EEPROMs, flash memory, solid state drives, magnetic or optical cards, application specific integrated circuits (ASICs), or any type of media suitable for storing electronic instructions, and each coupled to a computer system bus. Further, the computing devices referred to herein may include a single processor or may be architectures employing multiple processor designs for increased computing capability.

The algorithms and displays presented herein are not inherently related to any particular computing device, virtualized system, or other apparatus. Various general-purpose systems may also be used with programs in accordance with the teachings herein, or it may prove convenient to construct more specialized apparatus to perform the required method steps. The required structure for a variety of these systems will be apparent from the description provided herein. In addition, the system and method are not described with reference to any particular programming language. It will be appreciated that a variety of programming languages may be used to implement the teachings described herein, and any references above to specific languages are provided for disclosure of enablement and best mode.

Accordingly, various embodiments include software, hardware, and/or other elements for controlling a computer system, computing device, or other electronic device, or any combination or plurality thereof. Such an electronic device can include, for example, a processor, an input device (such as a keyboard, mouse, touchpad, track pad, joystick, trackball, microphone, and/or any combination thereof), an output device (such as a screen, speaker, and/or the like), memory, long-term storage (such as magnetic storage, optical storage, and/or the like), and/or network connectivity, according to techniques that are well known in the art. Such an electronic device may be portable or non-portable. Examples of electronic devices that may be used for implementing the described system and method include: a mobile phone, personal digital assistant, smartphone, kiosk, server computer, enterprise computing device, desktop computer, laptop computer, tablet computer, consumer electronic device, or the like. An electronic device may use any operating system such as, for example and without limitation: Linux; Microsoft Windows, available from Microsoft Corporation of Redmond, Wash.; Mac OS X, available from Apple Inc. of Cupertino, Calif.; iOS, available from Apple Inc. of Cupertino, Calif.; Android, available from Google, Inc. of Mountain View, Calif.; and/or any other operating system that is adapted for use on the device.

While a limited number of embodiments have been described herein, those skilled in the art, having benefit of the above description, will appreciate that other embodiments may be devised. In addition, it should be noted that the language used in the specification has been principally selected for readability and instructional purposes, and may not have been selected to delineate or circumscribe the subject matter. Accordingly, the disclosure is intended to be illustrative, but not limiting, of scope.

What is claimed is:

1. A computer-implemented method for generating a test suite recommendation, comprising:
extracting data describing elements of a software application for testing;
applying a machine learning engine to the extracted data, to generate at least one test suite recommendation;
outputting the generated at least one test suite recommendation;
receiving feedback regarding the output test suite recommendation; and
providing the received feedback to the machine learning engine.

2. The method of claim 1, wherein the extracted data describes at least one of features and bugs of the software application.

3. The method of claim 1, further comprising, prior to applying a machine learning engine to the extracted data, processing the extracted data.

4. The method of claim 1, further comprising automatically running at least one test from the recommended test suite on the software application.

5. The method of claim 1, further comprising iteratively repeating the extracting, applying, outputting, receiving, and providing steps.

6. The method of claim 1, wherein extracting data describing elements of a software application for testing comprises automatically obtaining data describing intended operation of the software.

7. The method of claim 1, wherein extracting data describing elements of a software application for testing comprises data extracted from at least one selected from the group consisting of:
a ticketing system for tracking issues with the software application;
available test suites;
at least one source control system; and
at least one release certification email.

8. The method of claim 1, wherein the machine learning engine is implemented using a plurality of machine learning libraries and at least one recommendation engine.

9. The method of claim 1, wherein the machine learning engine is implemented using a plurality of machine learning libraries.

10. A non-transitory computer-readable medium for generating a test suite recommendation, comprising instructions stored thereon, that when executed by one or more processors, perform the steps of:
extracting data describing elements of a software application for testing;
applying a machine learning engine to the extracted data, to generate at least one test suite recommendation;
causing an output device to output the generated at least one test suite recommendation;
causing an input device to receive feedback regarding the output test suite recommendation; and
providing the received feedback to the machine learning engine.

11. The non-transitory computer-readable medium of claim 10, wherein the extracted data describes at least one of features and bugs of the software application.

12. The non-transitory computer-readable medium of claim 10, further comprising instructions stored thereon, that when executed by one or more processors, perform the step of, prior to applying a machine learning engine to the extracted data, processing the extracted data.

13. The non-transitory computer-readable medium of claim 10, further comprising instructions stored thereon, that when executed by one or more processors, perform the step of automatically running at least one test from the recommended test suite on the software application.

14. The non-transitory computer-readable medium of claim 10, further comprising instructions stored thereon, that when executed by one or more processors, perform the step of iteratively repeating the extracting, applying, outputting, receiving, and providing steps.

15. The non-transitory computer-readable medium of claim 10, wherein extracting data describing elements of a software application for testing comprises automatically obtaining data describing intended operation of the software.

16. The non-transitory computer-readable medium of claim 10, wherein extracting data describing elements of a software application for testing comprises data extracted from at least one selected from the group consisting of:
a ticketing system for tracking issues with the software application;
available test suites;
at least one source control system; and
at least one release certification email.

17. The non-transitory computer-readable medium of claim 10, wherein the machine learning engine is implemented using a plurality of machine learning libraries and at least one recommendation engine.

18. The non-transitory computer-readable medium of claim 10, wherein the machine learning engine is implemented using a plurality of machine learning libraries.

19. A system for generating a test suite recommendation, comprising:
a machine learning engine, configured to receive data describing elements of a software application for testing, and further configured to generate at least one test suite recommendation;
an output device, communicatively coupled to the machine learning engine, configured to output the generated at least one test suite recommendation; and
an input device, communicatively coupled to the machine learning engine, configured to receive feedback regarding the output test suite recommendation and to provide the received feedback to the machine learning engine.

20. The system of claim 19, wherein the extracted data describes at least one of features and bugs of the software application.

21. The system of claim 19, further comprising a data processor, communicatively coupled to the machine learning engine, configured to process the data before it is provided to the machine learning engine.

22. The system of claim 19, further comprising a test application module, communicatively coupled to the machine learning engine, configured to automatically run at least one test from the recommended test suite on the software application.

23. The system of claim 19, wherein the machine learning engine operates iteratively.

24. The system of claim 19, wherein the data received by the machine learning engine describes intended operation of the software.

25. The system of claim 19, wherein the data received by the machine learning engine comprises data extracted from at least one selected from the group consisting of:
a ticketing system for tracking issues with the software application;
available test suites;
at least one source control system; and
at least one release certification email.

26. The system of claim 19, wherein the machine learning engine is implemented using a plurality of machine learning libraries and at least one recommendation engine.

27. The system of claim 19, wherein the machine learning engine is implemented using a plurality of machine learning libraries.
